(19) United States
(12) Patent Application Publication
(10) Pub. No.: US 2012/0245900 A1
(43) Pub. Date: Sep. 27, 2012

(54) COMPUTING DEVICE AND DESIGN METHOD FOR NONLINEAR OBJECT

(75) Inventors: CHENG-HSIEN LEE, Tu-Cheng (TW); HSIAO-YUN SU, Tu-Cheng (TW); SHOU-KUO HSU, Tu-Cheng (TW)

(73) Assignee: HON HAI PRECISION INDUSTRY CO., LTD., Tu-Cheng (TW)

(21) Appl. No.: 13/335,958

(22) Filed: Dec. 23, 2011

(30) Foreign Application Priority Data
Mar. 24, 2011 (TW) 100110068

(51) Int. Cl. G06F 17/50

(52) U.S. Cl. 703/1

(57) ABSTRACT

A design method generates a plurality of groups of experimental conditions, each of the groups of experimental conditions includes performance variables for an electronic product with nonlinear performance. The method simulates values to the groups of experimental conditions, computes an average value, and divides the groups of experimental conditions into a first part and a second part. The values in the first part is greater than the average value and the values in the second part is less than the average value. The method computes nonlinear boundary values of a refining mechanism based on the values, and determines a threshold value of the refiner. After refining the groups of experimental conditions, the method calculates the deviation of each value from the threshold value, and determines the groups of experimental conditions with the greatest deviations as optimal groups of experimental conditions.

### BACKGROUND

1. Technical Field

Embodiments of the present disclosure generally relate to computing devices and experimental design methods, and more particularly to a computing device and a design method for a nonlinear object.

2. Description of Related Art

A pre-routing simulation is usually performed before the design of most electronic product. The problem of estimating the influence of operating conditions upon the integrity of electronic signals of the product by using a pre-routing or preliminary simulation, is a difficult one. The variables in the conditions of operation may include different materials, and different conductor lengths, for example. To establish a correlation between the operating conditions and the product can reduce manufacturing time. However, if the product is nonlinear performance, any fixed correlation between the conditions of operation and the product itself cannot be accurately estimated.

### BRIEF DESCRIPTION OF THE DRAWINGS

FIG. 1 is a schematic diagram of one embodiment of a computing device including an experimental design unit.

FIG. 2 is a block diagram of function modules of the experimental design unit in FIG. 1.

FIG. 3 is a flowchart illustrating one embodiment of a design method for a nonlinear object.

FIG. 4 is a detailed description of step S07 in FIG. 3, for reclassifying groups of experimental conditions according to nonlinear boundary values and a threshold value of a refining mechanism.

FIG. 5, FIG. 6, FIG. 7, FIG. 8 and FIG. 9 give examples illustrating a correlation between a nonlinear object and performance variables of the nonlinear object.

### DETAILED DESCRIPTION

In general, the data “module,” as used herein, refers to logic embodied in hardware or firmware, or to a collection of software instructions, written in a programming language, such as, for example, Java, C, or assembly. One or more software instructions in the modules may be embedded in firmware, such as in an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable medium or other computer storage device. Some non-limiting examples of non-transitory computer-readable medium include CDs, DVDs, flash memory, and hard disk drives.

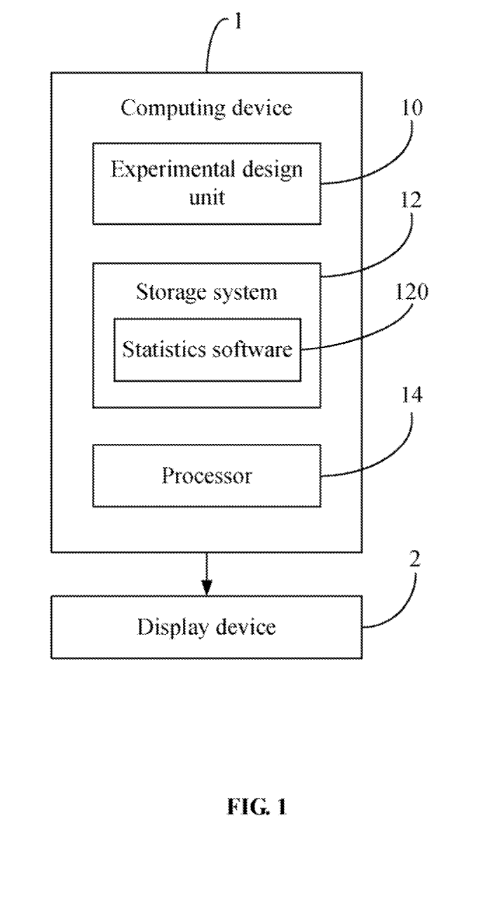

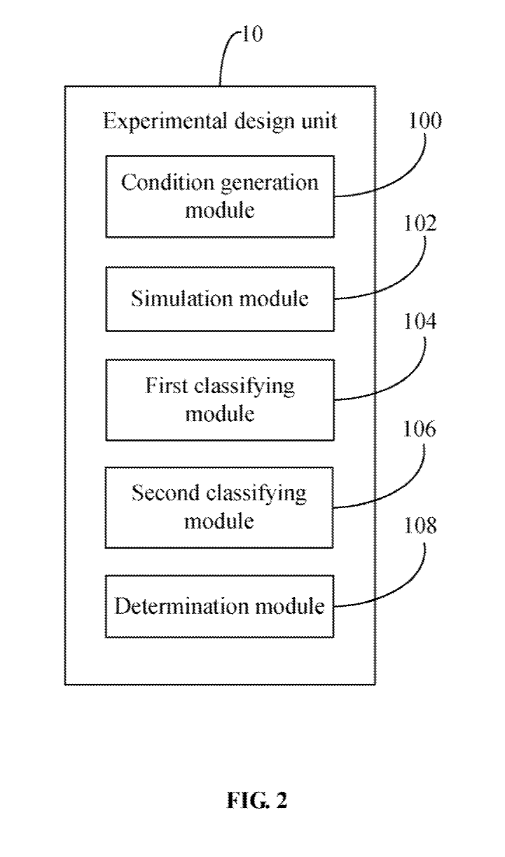

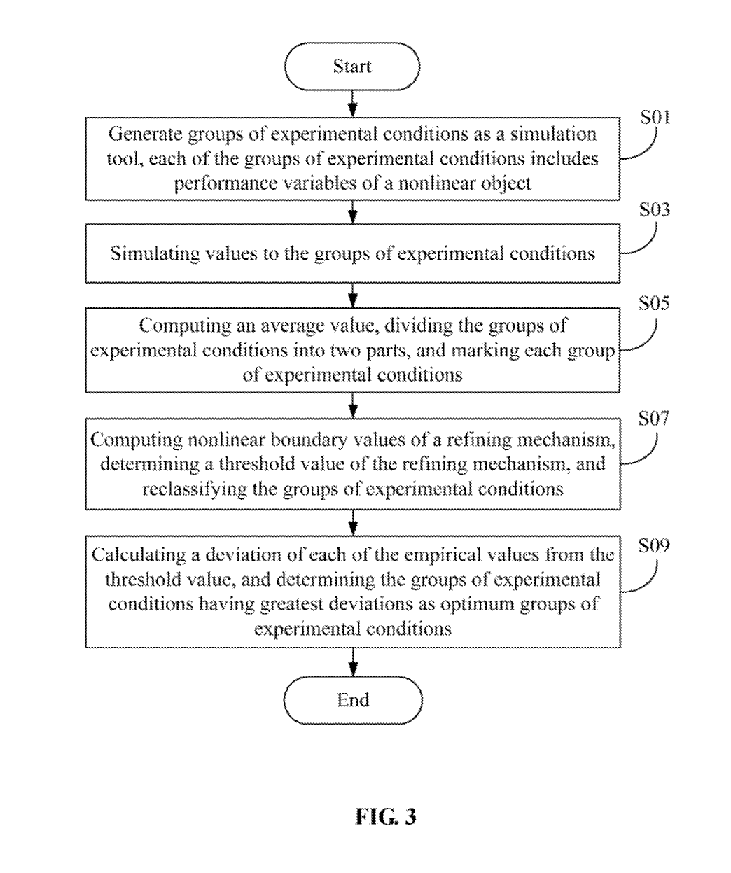

FIG. 1 is a block diagram of one embodiment of a computing device 1 including an experimental design unit 10. In the embodiment, functions of the experimental design unit 10 are implemented by the computing device 1. The experimental design unit 10 is used for generating a series of groups of experimental conditions applicable to the design of a product, or part of a product, with nonlinear performance (nonlinear object) using a statistics software 120, for example, the series of groups of experimental conditions are related to distances between an upper eyelid and a lower eyelid of the eye. The statistics software 120 may be a Minitab program. In the embodiment, each of the groups of experimental conditions includes at least one performance variable of the nonlinear object. For reducing design errors, the experimental design unit 10 can take the groups of experimental conditions as training data, and obtain an optimum, or number of optimum, groups of experimental conditions by analyzing the training data. Detail functions of the experimental design unit 10 are described, in reference to FIG. 2 and FIG. 3, below.

In one embodiment, the computing device 1 may be a computer, a server, a portable electronic device, or any other electronic device that includes a storage system 12, and at least one processor 14. In one embodiment, the storage system 12 may be a magnetic or an optical storage system, such as a hard disk drive, an optical drive, a compact disc, a digital versatile disc, a tape drive, or other suitable storage medium. The storage system 12 further stores the statistics software 120. The processor 14 may be a central processing unit including a math co-processor.

The computing device 1 is electronically connected to a display device 2. The display device 2 is configured for showing the experimental design process.

FIG. 2 is a block diagram of function modules of the experimental design unit 10 in FIG. 1. In one embodiment, the experimental design unit 10 includes a condition generation module 100, a simulation module 102, a first classifying module 104, a second classifying module 106, and a determination module 108. Each of the modules 100-108 may be a software program including one or more computerized instructions that are stored in the storage system 12 and executed by the processor 14.

The condition generation module 100 uses the statistics software 120 to generate a plurality of groups of experimental conditions as a simulation tool for simulating the design of the nonlinear object. Each of the groups of experimental conditions includes a series of performance variables of the nonlinear object. In the embodiment, the statistics software 120 may be a Minitab program, and the simulation tool may be a Taguchi Method or a Response Surface method, for example.

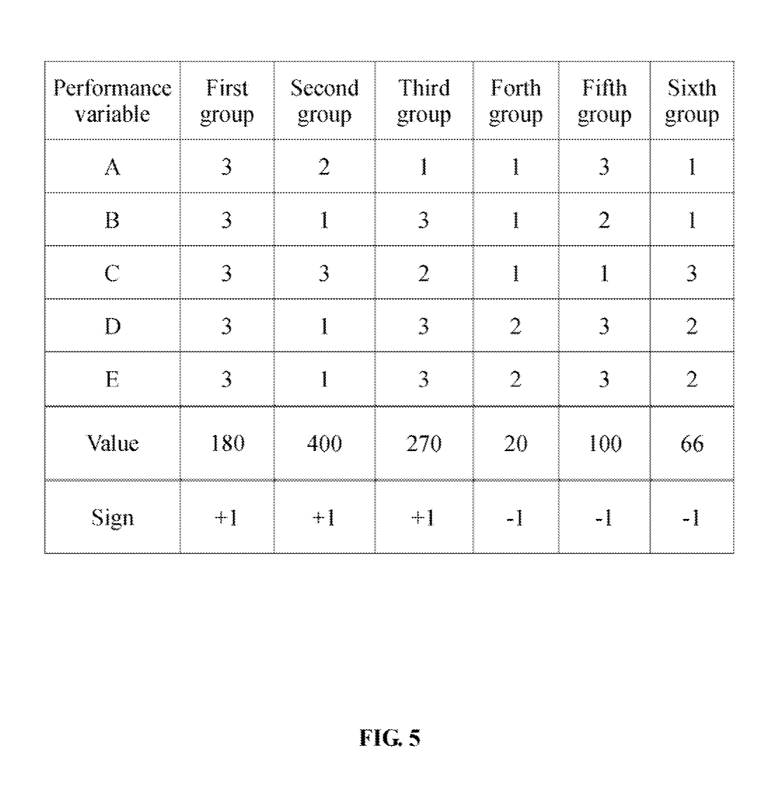

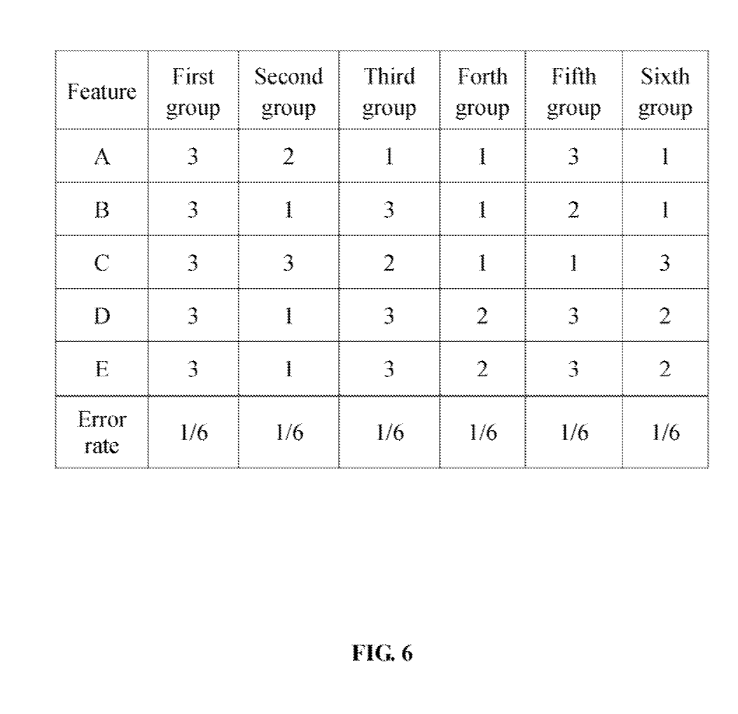

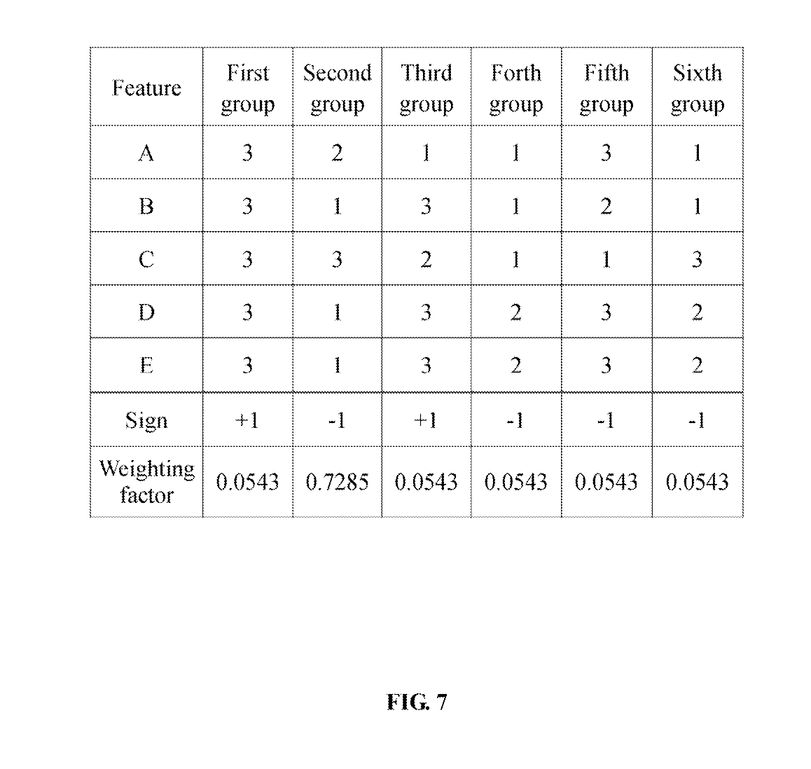

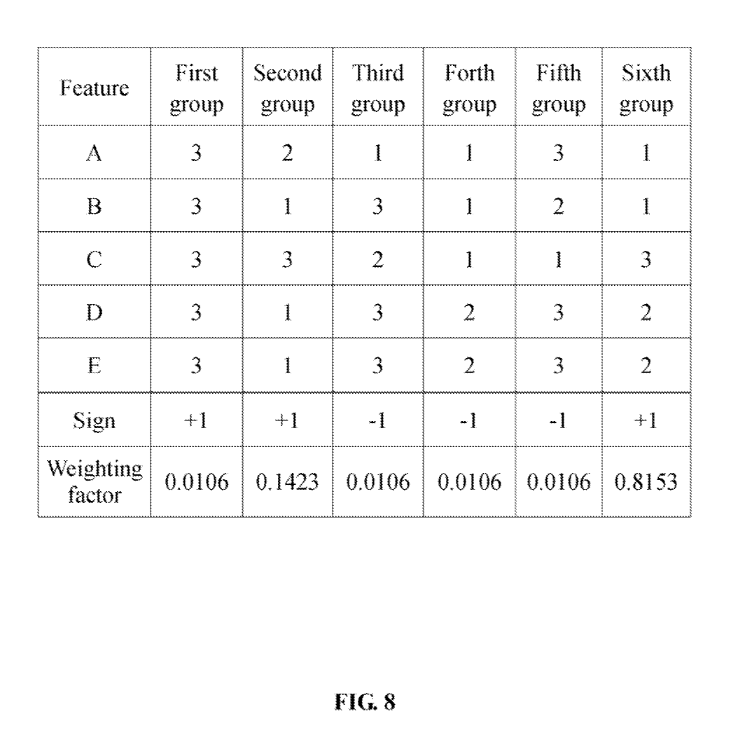

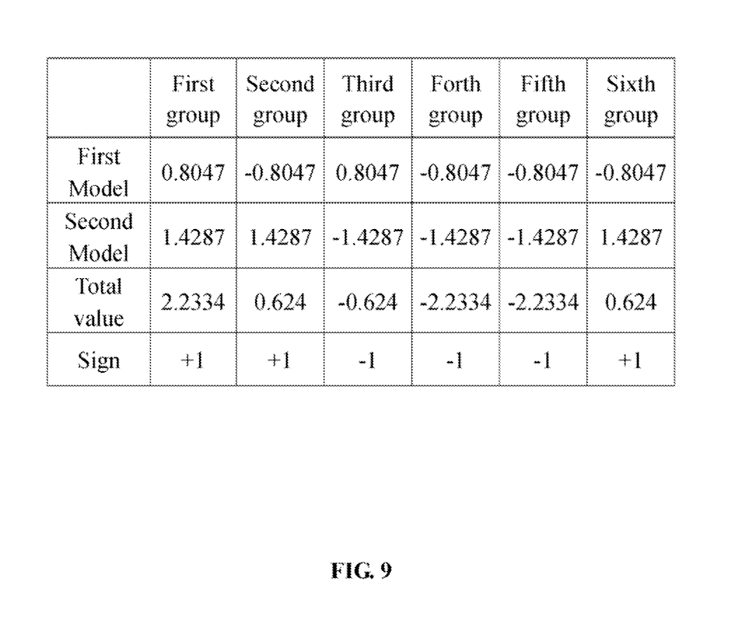

As shown in FIG. 5, the nonlinear object has five performance variables: A, B, C, D, and E. The condition generation module 100 uses the statistics software to generate six groups of experimental conditions: a first group, a second group, a third group, a forth group, a fifth group, and a sixth group.

The simulation module 102 simulates values to the groups of experimental conditions according to the simulation tool, on the basis of how the nonlinear product is likely to perform in actual operation under each of those conditions, or sets of conditions. In the embodiment, the values are results of the simulation of the nonlinear object. Different nonlinear object may have different values with units. For example, if the nonlinear object is an eye, the simulation module 102 may simulate a series of distances between an upper eyelid and a lower eyelid of the eye to the groups of experimental conditions, and units of the distances can be in mm or in cm. As shown in FIG. 5, the value of the first group is “180,” the value of the second group is “400,” the value of the third group is “270,” the value of the forth group is “20,” the value of the fifth group is “100,” and the value of the sixth group is “66.”

The first classifying module 104 computes an average value of the values, and divides the groups of experimental conditions into a first part and a second part according to the average value. In the embodiment, the values in the first part is greater than the average value, and the values in the second part is less than the average value. As shown in FIG. 5, the first classifying module 104 further marks the groups of experimental conditions in the first part with a first positive “+1” sign, and marks the groups of experimental conditions in the second part with a second negative “−1” sign.

An error rate of each group of experimental conditions (in FIG. 5) is about one-sixth (as shown in FIG. 6), and establishing an optimum group of experimental conditions is therefore difficult. The error rate is a rate of an error would happen. Thus, the simulation tool is required to use a refining mechanism to classify the groups of experimental conditions and apply weights in each group of experimental conditions, namely to reduce the weights for correct factors, and enhance the weights for error factors, to assist in highlighting one or more of an optimum group of experimental conditions.

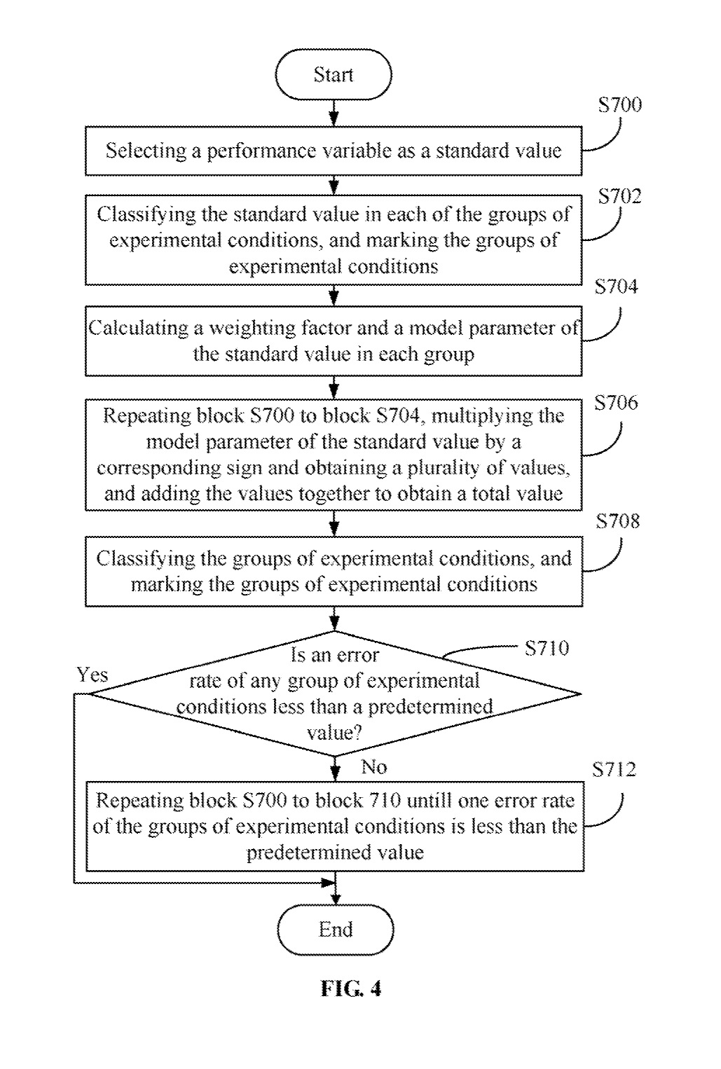

The second classifying module 106 computes nonlinear boundary values for the refining mechanism based on the values divided into the two parts, and determines a threshold value of the refining mechanism from the nonlinear boundary values. In one embodiment, the nonlinear boundary values are the result of a weighting factor and a model parameter of each of the performance variables. The refining mechanism follows a boosting algorithm. The second classifying module 106 further reclassifies the groups of experimental conditions according to the nonlinear boundary values and the threshold value of the refining mechanism, as detailed below (and illustrated in FIG. 4).

The determination module 108 calculates a deviation of each of the values in the groups of experimental conditions from the threshold value, and determines the groups of experimental conditions having a maximum deviation as the optimum groups of experimental conditions. As illustrated in FIG. 9, if the threshold value is zero, the deviation between each of the values and the threshold value is “2.234,” “0.624,” “0.624,” “2.234,” “2.234,” and “0.624”. The determination module 108 determines that the first group, the forth group and the fifth group have the greatest deviations, so the first group, the forth group and the fifth group can be determined as the optimum groups of experimental conditions. The error rates of the first group, the forth group and the fifth group are low.

FIG. 3 is a flowchart illustrating one embodiment of a method for designing a nonlinear object using the computing device 1 of FIG. 1. The method can be performed by the execution of a computer-readable program by the at least one processor 12. Depending on the embodiment, in FIG. 3, additional steps may be added, others removed, and the ordering of the steps may be changed.

In step S01, the condition generation module 100 uses the statistics software 120 to generate a plurality of groups of experimental conditions as a simulation tool for simulating the conditions of operation of a nonlinear object. As shown in FIG. 5, each of the groups of experimental conditions includes a series of performance variables of the nonlinear object. In the embodiment, the statistics software 120 may be a Minitab program, and the simulation tool may be a Taguchi Method or a Response Surface method, for example.

In step S03, the simulation module 102 simulates values for the groups of experimental conditions according to the simulation tool. As shown in FIG. 5, the value of the first group is “180,” the value of the second group is “400,” the value of the third group is “270,” the value of the forth group is “20,” the value of the fifth group is “100,” and the value of the sixth group is “66.”

In step S05, the first classifying module 104 computes an average value of the values, divides the groups of experimental conditions into a first part and a second part according to the average value, and marks the first part with a first sign and marks the second part with a second sign. In the embodiment, the values in the first part are greater than the average value, and the values in the second part are less than the average value. The first sign may be “+1” which is different from the second sign. In one embodiment, the second sign can be “−1.”

In step S07, the second classifying module 106 computes the nonlinear boundary values of a refining mechanism based on the values in the two parts, determines a threshold value of the refining mechanism from the nonlinear boundary values, and reclassifies the groups of experimental conditions according to the nonlinear boundary values and the threshold value of the refining mechanism, as below (and detailed in FIG. 4). In one embodiment, the nonlinear boundary values are the result of a weighting factor and a model parameter of each of the performance variables. The refining mechanism follows a boosting algorithm.

In step S09, the determination module 108 calculates a deviation of each of the values in the groups of experimental conditions from the threshold value, and determines the groups of experimental conditions having the greatest deviations as the optimum groups of experimental conditions of the nonlinear object. The determination module 108 further generates and projects the nonlinear object according to the optimum groups of experimental conditions, and displays the nonlinear object on the display device 2.

As illustrated in FIG. 9, if the threshold value is zero, the deviation between each of the values and the threshold value is “2.234,” “0.624,” “0.624,” “2.234,” “2.234,” and “0.624”. The determination module 108 determines that the first group, the forth group and the fifth group can be the optimum groups of experimental conditions relating to the nonlinear object. The error rates of the first group, the forth group and the fifth group are low.

FIG. 4 is a detailed description of step S07 in FIG. 3, for reclassifying groups of experimental conditions according to the nonlinear boundary values and the threshold value of the refining mechanism.

In step S700, the second classifying module 106 determines the performance variables as features, and selects a feature as a standard value. In another embodiment, the second classifying module 106 can select more than one feature as the standard value.

In step S702, the second classifying module 106 presets a conditional criterion, classifies the standard value in each of the groups of experimental conditions according to the conditional criterion, marks the groups of experimental conditions as the first sign “+1” in which the standard value is greater than the conditional criterion, and marks the groups of experimental conditions as the second sign “−1” for which the standard value is less than the conditional criterion.

For example, as shown in FIG. 6, if the feature B is selected to be the standard value and the digital “2” is preset as the conditional criterion, the second classifying module 106 marks the first group and the third group with the first sign “+1,” and marks the second group, the forth group, the fifth group and the sixth group with the second sign “−1”. By comparing the sign of each group in FIG. 6 with the corresponding sign in FIG. 5, the second classifying module 106 finds that the second group has a different sign in FIG. 6 and FIG. 5, so the second classifying module 106 determines that the error rate of the second group is too high, which can be verified in step S704 below. If the feature C is selected to be the standard value and the digital number “2” is preset as the conditional criterion, the second classifying module 106 marks the first group, the second group and the fifth group with the first sign “+1,” and marks the third group, the forth group, and the fifth group with the second sign “−1”. By comparing the sign of each group in FIG. 6 with the corresponding sign in FIG. 5, the second classifying module 106 finds that the third group and the sixth group have different signs in FIG. 6 and FIG. 5, so the second classifying module 106 determines that the error rates of the third group and the sixth group are too high, which can illustrated in FIG. 7.

In step S704, the second classifying module 106 uses the refining mechanism to calculate a weighting factor and a model parameter of the standard value in each of the groups of experimental conditions. In the embodiment, the process of selecting one or more features as the standard value can serve as the process of establishing models. For example, if the refining mechanism follows the boosting algorithm, the weighting factor can be calculated with the following formula: Di+1=Di*exp(−α*y*h)/Z, where the model parameter can be calculated with the formula: α=ln(1−ε/ε)/2, “ε” is the error rate, “y” is a value of the sign, “h” represents whether the classification is right (if the classification is wrong: y*h=−1, if the classification is right, y*h=1), “Z” is a normalize factor. For example, if the substitution of ε=⅙ is made in the formula given above and then solve it for α=0.8047, as shown in FIG. 7, the total value of the weighting factors of the feature B in the six groups of experimental conditions is equal to one.

In step S706, the second classifying module 106 repeats step S700 to step S704 to determine each performance variable as the standard value and calculate the weighting factor and the model parameter of the standard value. The second classifying module 106 multiplies the model parameter of the standard value in each of the groups of experimental conditions by the corresponding sign and obtains a plurality of values, and adds the plurality of values together to obtain a total value. In the embodiment, each of the groups of experimental conditions corresponds to a total value of one.

As shown in FIG. 7, the signs of the feature B in each experimental condition group are marked as “+1,” “−1,” “+1,” “−1,” “−1,” and “−1,” the second classifying module 106 calculates that the model parameter of the feature B is α=0.8047. As shown in FIG. 8, the signs of the feature C in each experimental condition group are marked as “+1,” “+1,” “−1,” “−1,” “−1,” and “+1,” the second classifying module 106 calculates that the model parameter of the feature C is α=1.4287. If the process of judging the feature B is determined as a first model, and the process of judging the feature C is determined as a second model, the value of multiplying the model parameter of the feature B by the corresponding sign and the value of multiplying the model parameter of the feature C by the corresponding sign are shown in FIG. 9.

In step S708, the second classifying module 106 classifies the groups of experimental conditions according to the threshold value of the refining mechanism, and marks with sign “+1” the groups of experimental conditions in which the total values are greater than the threshold value, and marks with sign “−1” the groups of experimental conditions in which the total values are less than the threshold value. As shown in FIG. 9, if zero is the threshold value, the second classifying module 106 classifies the groups of experimental conditions into two parts: the first group, the second group and the sixth group compose one group, which is marked with the first sign “+1,” and the third group, the forth group, ad the fifth group compose another part, which is marked with the second sign “−1”.

In step S710, the determination module 108 determines whether an error rate of each experimental condition group is less than a predetermined value by comparing the sign of each experimental condition group in FIG. 9 with the corresponding sign in FIG. 5. If the error rate of each experimental condition group is less than the predetermined value, the flow ends. If the error rate of each experimental condition group is not less than the predetermined value, the flow goes to step S712.

For example, if the predetermined value is three, the determination module 108 determines that the error rates of the third group and the sixth group are not less than the predetermined value.

In step S712, the determination module 108 repeats step S700 to step S710 until one error rate of the groups of experimental conditions is less than the predetermined value.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A design method of a nonlinear object using a computing device, the design method comprising:
(a) using a statistics software to generate a plurality of groups of experimental conditions as a simulation tool for simulating the nonlinear object, each of the groups of experimental conditions comprising a plurality of performance variables of the nonlinear object;
(b) simulating values to the groups of experimental conditions according to the simulation tool;
(c) computing an average value of the values, and dividing the groups of experimental conditions into a first part and a second part according to the average value;
(d) computing nonlinear boundary values of a refining mechanism based on the values in the two parts, and determining a threshold value of the refining mechanism from the nonlinear boundary values;
(e) reclassifying the groups of experimental conditions according to the nonlinear boundary values and the threshold value of the refining mechanism;
(f) calculating a deviation of each of the values in the groups of experimental conditions from the threshold value, and determining the groups of experimental conditions having greatest deviations as optimum groups of experimental conditions; and
(g) generating and projecting the nonlinear object according to the optimum groups of experimental conditions, and displaying the nonlinear object on a display device connected to the computing device.

2. The method as claimed in claim 1, wherein the statistics software is a Minitab program.

3. The method as claimed in claim 1, wherein the simulation tool is a Taguchi Method or a Response Surface method.

4. The method as claimed in claim 1, wherein each of the values in the first part is greater than the average value, and each of the values in the second part is less than the average value.

5. The method as claimed in claim 1, wherein the nonlinear boundary values are composed by a weighting factor and a model parameter of each of the performance variables.

6. The method as claimed in claim 1, wherein the step (c) further comprises:
(c1) marking the groups of experimental conditions in the first part with a first sign, and marking the groups of experimental conditions in the second part with a second sign.

7. The method as claimed in claim 6, wherein the step (e) comprises:
(e1) selecting a performance variable as a standard value;
(e2) classifying the standard value in each of the groups of experimental conditions according to a conditional criterion, marking with the first sign the groups of experimental conditions in which the standard value is greater than the conditional criterion, and marking with the second sign the groups of experimental conditions in which the standard value is less than the conditional criterion;
(e3) calculating a weighting factor and a model parameter of the standard value in each of the groups of experimental conditions;
(e4) repeating step (e1) to step (e3) to determine each performance variable as the standard value and calculating the weighting factor and the model parameter of the standard value;
(e5) multiplying the model parameter of the standard value in each of the groups of experimental conditions by the corresponding first or second sign and obtaining a plurality of values, and adding the plurality of values together to obtain a total value, each of the groups of experimental conditions corresponds to one total value;
(e6) classifying the groups of experimental conditions according to the threshold value of the refining mechanism, marking with the first sign the groups of experimental conditions in which the total values are greater than the threshold value, and marking with the second sign the groups of experimental conditions in which the total values are less than the threshold value; and
(e7) determining whether an error rate of each of the groups of experimental conditions is less than a predetermined value by comparing the sign of each of the groups of experimental conditions in step (e6) with the corresponding first or second sign in step (e1).

8. A computing device, comprising:
at least one processor;
a storage system; and
one or more modules that are stored in the storage system and executed by the at least one processor, the one or more modules comprising:
a condition generation module operable to use a statistics software to generate a plurality of groups of experimental conditions as a simulation tool for simulating a nonlinear object, each of the groups of experimental conditions comprising a plurality of performance variables of the nonlinear object;
a simulation module operable to simulate values to the groups of experimental conditions according to the simulation tool;
a first classifying module operable to compute an average value of the values, and divide the groups of experimental conditions into a first part and a second part according to the average value;
a second classifying module operable to compute nonlinear boundary values of a refining mechanism based on the values in the two parts, determine a threshold value of the refining mechanism from the nonlinear boundary values, and reclassify the groups of experimental conditions according to the nonlinear boundary values and the threshold value of the refining mechanism; and
a determination module operable to calculate a deviation of each of the values in the groups of experimental conditions from the threshold value, determine the groups of experimental conditions having greatest deviations as optimum groups of experimental conditions, generate and projecting the nonlinear object according to the optimum groups of experimental conditions, and display the nonlinear object on a display device connected to the computing device.

9. The computing device as claimed in claim 8, wherein the statistics software a is Minitab program.

10. The computing device as claimed in claim 8, wherein the simulation tool is a Taguchi Method or a Response Surface method.

11. The computing device as claimed in claim 8, wherein each of the values in the first part is greater than the average value, and each of the values in the second part is less than the average value.

12. The computing device as claimed in claim 8, wherein the nonlinear boundary values are composed by a weighting factor and a model parameter of each of the performance variables.

13. The computing device as claimed in claim 8, wherein the first classifying module is further operable to mark the groups of experimental conditions in the first part with a first sign, and mark the groups of experimental conditions in the second part with a second sign.

14. The computing device as claimed in claim 13, wherein the groups of experimental conditions is reclassified according to the nonlinear boundary values and the threshold value of the refining mechanism by the following steps:
(e1) selecting a performance variable as a standard value;
(e2) classifying the standard value in each of the groups of experimental conditions according to a conditional criterion, marking with the first sign the groups of experimental conditions in which the standard value is greater than the conditional criterion, and marking with the second sign the groups of experimental conditions in which the standard value is less than the conditional criterion;
(e3) calculating a weighting factor and a model parameter of the standard value in each of the groups of experimental conditions;
(e4) repeating step (e1) to step (e3) to determine each performance variable as the standard value and calculating the weighting factor and the model parameter of the standard value;
(e5) multiplying the model parameter of the standard value in each of the groups of experimental conditions by the corresponding first or second sign and obtaining a plurality of values, and adding the plurality of values together to obtain a total value, each of the groups of experimental conditions corresponds to one total value;
(e6) classifying the groups of experimental conditions according to the threshold value of the refining mechanism, marking with the first sign the groups of experimental conditions in which the total values are greater than the threshold value, and marking with the second sign the groups of experimental conditions in which the total values are less than the threshold value; and
(e7) determining whether an error rate of each of the groups of experimental conditions is less than a predetermined value by comparing the sign of each of the groups of experimental conditions in step (e6) with the corresponding first or second sign marked by the first classifying module.

15. A non-transitory storage medium having stored thereon instructions that, when executed by a processor of a computing device, cause the computing device to:
(a) use a statistics software to generate a plurality of groups of experimental conditions as a simulation tool for simulating the nonlinear object, each of the groups of experimental conditions comprising a plurality of performance variables of the nonlinear object;
(b) simulate values to the groups of experimental conditions according to the simulation tool;
(c) compute an average value of the values, and divide the groups of experimental conditions into a first part and a second part according to the average value;
(d) compute nonlinear boundary values of a refining mechanism based on the values in the two parts, and determine a threshold value of the refining mechanism from the nonlinear boundary values;
(e) reclassify the groups of experimental conditions according to the nonlinear boundary values and the threshold value of the refining mechanism;
(f) calculate a deviation of each of the values in the groups of experimental conditions from the threshold value, and determine the groups of experimental conditions having greatest deviations as optimum groups of experimental conditions; and
(g) generate and project the nonlinear object according to the optimum groups of experimental conditions, and display the nonlinear object on a display device connected to the computing device.

16. The storage medium as claimed in claim 15, wherein each of the values in the first part is greater than the average value, and each of the values in the second part is less than the average value.

17. The storage medium as claimed in claim 15, wherein the simulation tool is a Taguchi Method or a Response Surface method.

18. The storage medium as claimed in claim 15, wherein the nonlinear boundary values are composed by a weighting factor and a model parameter of each of the performance variables.

19. The storage medium as claimed in claim 15, wherein the step (c) further comprises:
(c1) marking the groups of experimental conditions in the first part with a first sign, and marking the groups of experimental conditions in the second part with a second sign.

20. The storage medium as claimed in claim 19, wherein the step (e) comprises:
(e1) selecting a performance variable as a standard value;
(e2) classifying the standard value in each of the groups of experimental conditions according to a conditional criterion, marking with the first sign the groups of experimental conditions in which the standard value is greater than the conditional criterion, and marking with the second sign the groups of experimental conditions in which the standard value is less than the conditional criterion;
(e3) calculating a weighting factor and a model parameter of the standard value in each of the groups of experimental conditions;
(e4) repeating step (e1) to step (e3) to determine each performance variable as the standard value and calculating the weighting factor and the model parameter of the standard value;
(e5) multiplying the model parameter of the standard value in each of the groups of experimental conditions by the corresponding first or second sign and obtaining a plurality of values, and adding the plurality of values together to obtain a total value, each of the groups of experimental conditions corresponds to one total value;
(e6) classifying the groups of experimental conditions according to the threshold value of the refining mechanism, marking with the first sign the groups of experimental conditions in which the total values are greater than the threshold value, and marking with the second sign the groups of experimental conditions in which the total values are less than the threshold value; and
(e7) determining whether an error rate of each of the groups of experimental conditions is less than a predetermined value by comparing the sign of each of the groups of experimental conditions in step (e6) with the corresponding first or second sign in step (e1).
